(19) United States
(12) Patent Application Publication
(10) Pub. No.: US 2026/0107299 A1
(43) Pub. Date: Apr. 16, 2026

(54) NON-PRIMARY CHANNEL ACCESS WITH DYNAMIC BANDWIDTH EXPANSION

(71) Applicant: Cisco Technology, Inc., San Jose, CA (US)

(72) Inventors: Binita GUPTA, San Diego, CA (US); Malcolm M. SMITH, Richardson, TX (US); Brian D. HART, Sunnyvale, CA (US)

(21) Appl. No.: 19/296,810

(22) Filed: Aug. 11, 2025

Related U.S. Application Data
(60) Provisional application No. 63/707,674, filed on Oct. 15, 2024.
(60) Provisional application No. 63/830,341, filed on Jun. 25, 2025.

(51) Int. Cl. H04W 74/00

(52) U.S. Cl. CPC H04W 74/002

(57) ABSTRACT

An access point (AP) can account for Non-Primary Channel Access (NPCA) operation during Dynamic BW Expansion (DBE) where a BW of a BSS is expanded or reduced. When BSS BW is dynamically expanded using DBE, the embodiments herein provide signaling and behaviors performed by the AP such that NPCA can operate over the expanded BW. In one embodiment, the AP updates an NPCA primary channel (NPCH) used during NPCA when changing the BW of a BSS/AP during DBE. For example, NPCA may already be enabled in the BSS in which case the AP moves the NPCH to a new channel that is within the expanded BW. In another embodiment, NPCA is not enabled in the BSS before the BW is expanded in which case the AP enables NPCA during the BDE session.

### CROSS-REFERENCE TO RELATED APPLICATIONS

This application claims benefit of co-pending United States provisional patent application Ser. No. 63/830,341 filed Jun. 25, 2025, and co-pending United States provisional patent application Ser. No. 63/707,674 filed Oct. 15, 2024. The aforementioned related patent application is herein incorporated by reference in its entirety.

### TECHNICAL FIELD

Embodiments presented in this disclosure generally relate to performing Non-Primary Channel Access (NPCA) during a dynamic bandwidth expansion (DBE) session.

### BACKGROUND

Even with wider bandwidth (BW) support of 160 and 320 MHz, for any 802.11 transmission, the primary channel for the basic service set (BSS) (e.g., typically 20 MHz) must be idle to access the wider channel BW (>20 MHz). This leads to inefficient spectrum utilization, especially for wider channel BW of 160 and 320 MHz, where an overlapping BSS (OBSS) or other interference on the primary 20 MHz channel can lead to not using the entire 160 or 320 MHz channel BW. To address this issue, NPCA has been introduced as a mechanism for efficient use of access point's (AP) operating BW. In NPCA, when an OBSS transmission is detected on the primary channel, both the AP and the station (STA) switch to a secondary/non-primary channel for transmission. For NPCA operation, the AP advertises an NPCA primary channel (NPCH) and NPCA channel BW in the BSS. Both the AP and STA switch to the NPCH if OBSS transmission is detected on the primary channel for the BSS.

Real Time DBE (RT-DBE) is a solution for dynamically changing BSS BW in real time at the time scale of milliseconds and seconds, as opposed to radio resource management (RRM) based solutions where BSS BW can be changed at time scale of minutes/hours. The RT-DBE solution enables opportunistic expansion of BSS BW to exploit temporal variations in load and interference conditions among neighboring APs, e.g., expanding BSS BW from 40 MHz to 160 MHz for several seconds, when low co-channel interference (CCI) and low channel utilization (CU) is detected on adjacent channels leading to conclusions that the adjacent channels are “sufficiently clear” for BW expansion. RT-DBE enables opportunistic use of wider BW in enterprise deployments, improving performance and overall spectrum efficiency.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates a wireless network that accounts for NPCA during DBE, according to one embodiment.

FIG. 2 is a flowchart for establishing a NPCH during DBE, according to one embodiment.

FIG. 3 is a flowchart for changing a NPCH during DBE, according to one embodiment.

FIGS. 4A and 4B illustrate changing a NPCH during DBE, according to one embodiment.

FIG. 5 is a flowchart for enabling a NPCH during DBE, according to one embodiment.

FIG. 6 depicts an example computing device configured to perform various aspects of the present disclosure, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is an AP that includes one or more memories and one or more processors communicatively coupled to the one or more memories, wherein the one or more processors are configured to, individually or collectively, perform operations. The operations include determining to expand a bandwidth of a basic service set (BSS) and in response to determining to expand the bandwidth, transmitting a message comprising a primary channel for performing NPCA over the expanded bandwidth.

Another embodiment presented in this disclosure is a method that includes determining to expand a bandwidth of a BSS and in response to determining to expand the bandwidth, transmitting a message from an AP that comprises a primary channel for performing NPCA over the expanded bandwidth.

Another embodiment presented in this disclosure is a non-transitory computer-readable medium that includes, in any combination, computer program code, which, when executed by one or more processors, performs operations. The operations include determining to expand a bandwidth of a BSS and in response to determining to expand the bandwidth, transmitting a message from an AP that comprises a primary channel for performing NPCA over the expanded bandwidth.

### Example Embodiments

The embodiments herein account for NPCA operation during DBE where a BW of a BSS (e.g., a BW of an AP) is expanded or reduced. When BSS BW is dynamically expanded using DBE, the embodiments herein provide signaling and behaviors performed by the AP such that NPCA can operate over the expanded BW.

The AP updates the NPCH used during NPCA when changing the BW of a BSS/AP during DBE. In one embodiment, NPCA is already enabled in the BSS. The AP may then change the NPCH to take advantage of the increased BW (e.g., change the NPCH to a channel that has less interference). The change in the NPCH can be synchronized with the change in BW. However, some STAs associated with the AP may not support DBE. Changing the NPCH to be within the expanded BW may mean those STAs cannot perform NPCA. As such, the AP may poll the STAs to determine how many can support DBE before changing the NPCH. If few STAs support DBE, the AP may decide to keep the same NPCH during a DBE session.

In another embodiment, NPCA is not currently enabled in the BSS (e.g., the BSS may not have enough BW to support having a NPCH). However, once the BW is expanded during the DBE session, the BSS may now have enough BW for NPCH. In that case, when expanding the BW, the AP can announce that NPCA will also be enabled and provide a NPCH for performing NPCA. If the BW is reduced to the original BSS BW, the AP can disable NPCA, which means the NPCH is no longer usable. In this manner, rather than changing a NPCH during a DBE session, here a NPCH is available only during the DBE session.

Before discussing the interoperability of NPCA and DBE, a brief introduction of DBE and NPCA is provided next.

A BSS is a fundamental building block of a wireless local area network (WLAN), including an AP and one or more wireless client stations like laptops and smartphones. Channel Switch Announcement (CSA) or Extended CSA (E-CSA) in IEEE 802.11 standard can support changing the operating BW of a BSS. However, using existing CSA or E-CSA to obtain more frequency or perform dynamic bandwidth change has undesirable impacts on legacy devices. For example, most legacy STAs respond to CSA/E-CSA by roaming away and then roaming back (causing double scan/roam hit). To perform BW expansion using CSA/E-CSA (e.g., every few seconds or minutes), the double roaming has a serious negative impact on the performance of the legacy STAs. In addition, some legacy STAs will not associate with an AP that supports CSA. Further, CSA/E-CSA BW changes are designed for use with RRM, which is primarily for non-real time (or longer time scale) changes to channel and BW selection, and is not expected to be used for fast/real-time/frequent BW changes (e.g., at each transmit opportunity (TXOP) level, every millisecond, every second, or every minute or every few minutes etc.). In addition, the CSA/ECSA is mainly used for changing the primary channel of the BSS, which is not the case for DBE (or RT-DBE), where the primary 20 MHz channel for the BSS remains the same and only BW changes. Using CSA/ECSA for only bandwidth changes may cause field interoperability issues with legacy devices.

To perform RT DBE, the AP and STAs exchange signals indicating their respective DBE capabilities (e.g., whether DBE is supported, maximum DBE dynamic BW supported, list of one or more dynamic BW supported etc.). Later, the AP (or a network controller) can determine to perform DBE. For example, the load on the AP may jump because the AP is located in a conference room or an event center. To provide additional BW to serve higher loads, the AP (or the RRM logic or controller) can determine to perform a DBE operation which makes the wider channel BWs available to the AP, e.g., 80 MHz, 160 MHz or 320 MHz. To do so, the AP transmits a DBE announcement in advance to inform the STAs about an upcoming expanded BW. This announcement can include information of the expanded DBE bandwidth such as expanded DBE channel bandwidth, center frequency for the expanded BW, whether one or more sub-channel is punctured within the expanded BW, etc. and indicate the start time (or the DBE BW switch time) when the BW will be expanded. The DBE BW switch time can be indicated, e.g., as the number of target beacon transmission times (TBTTs) till the AP switches to the DBE BW or a future timing synchronization function (TSF) time when the DBE BW switch happens. The DBE announcement can be sent for certain beacon intervals in advance (before DBE BW change takes place) e.g., sent for few delivery traffic indication map (DTIM) beacon intervals or can be sent for larger number of beacon intervals based on the listen interval of associated STAs that support DBE. This enables STAs to prepare and get ready to operate at the expanded BW. In one embodiment, signaling for the advance DBE announcement can be provided as part of one or more of beacon, probe response, fast initial link setup (FILS) discovery or (re)association response frames.

Once the BW is expanded, the AP operates with an active DBE mode or active DBE session. The AP also indicates to the STA that it is operating with DBE expanded BW (active DBE session or mode) and indicates expanded DBE bandwidth parameters to the STAs. As above, the DBE bandwidth parameters provided after BW expansion can include expanded DBE bandwidth, channel center frequency for the expanded BW, whether one or more sub channels are punctured within the expanded BW, etc. DBE bandwidth parameters provided after BW expansion can be indicated in beacon, probe response, FILS discovery or (re)association response frames. This signaling from the AP can be used to notify STAs that may have been sleeping that a DBE session or mode is currently active in the BSS.

In some embodiments, the current DBE BW remains active until the AP sends another DBE announcement to change the DBE BW or terminate the DBE session. The subsequent DBE announcement to make changes or terminate DBE mode is also announced for some time duration in advance, e.g., a certain number of beacon intervals. In some embodiments, the AP may change DBE bandwidth of a currently active DBE session to another DBE bandwidth, e.g., change DBE BW from 160 MHz to 320 MHz. The AP can achieve this by sending another DBE announcement indicating DBE bandwidth parameters for the changed DBE BW. In some embodiments, the DBE mode (or session) remains active until the AP sends another DBE announcement indicating the termination of the DBE mode. For example, the AP may wait until its load decreases to terminate the active DBE mode/session. However, in another example, the original DBE announcement can include a duration indicating a start and stop time of the DBE session. After the DBE session is terminated, the AP and DBE supporting STAs return to operating at the BSS operating BW.

Turning to NPCA, NPCA is a mechanism for efficient use of an AP's operating BW. With NPCA, when an OBSS transmission is detected on the primary channel of the BSS, both the AP and STA switch to a secondary/non-primary channel for transmission, which is referred to as the NPCA primary channel or NPCH. OBSS refers to the situation where multiple Wi-Fi network (or BSSs) are operating on the same or overlapping channels. This can lead to interference and degraded performance. As such, NPCA provides a secondary/non-primary channel (i.e., the NPCH) that the AP and a STA can switch to for Tx/Rx operation when an OBSS transmission is detected on the primary channel of the BSS. The AP and STA can then use the NPCH to perform the functions that would normally be performed on the primary channel of the BSS (e.g., clear channel assessment (CCA), channel access, Tx/Rx exchange).

The AP can advertise the NPCH (e.g. in beacon, probe response, (re)association response) before there is any problem detected on the primary channel of the BSS. Then, when an OBSS transmission is detected on the primary channel, the AP and the STAs can use the NPCH indicated in the NPCA announcement and/or in the management frames mentioned above to contend for wireless resources - i.e., the NPCH can be used as the channel for operation in the BSS when OBSS is detected on the primary channel. The NPCH can be updated using an NPCA announcements that can be a critical update announcement, and can be included in a management frame of the BSS, such as a beacon, probe response, or an Extended Channel Switch Announcement (E-CSA) or another management frame.

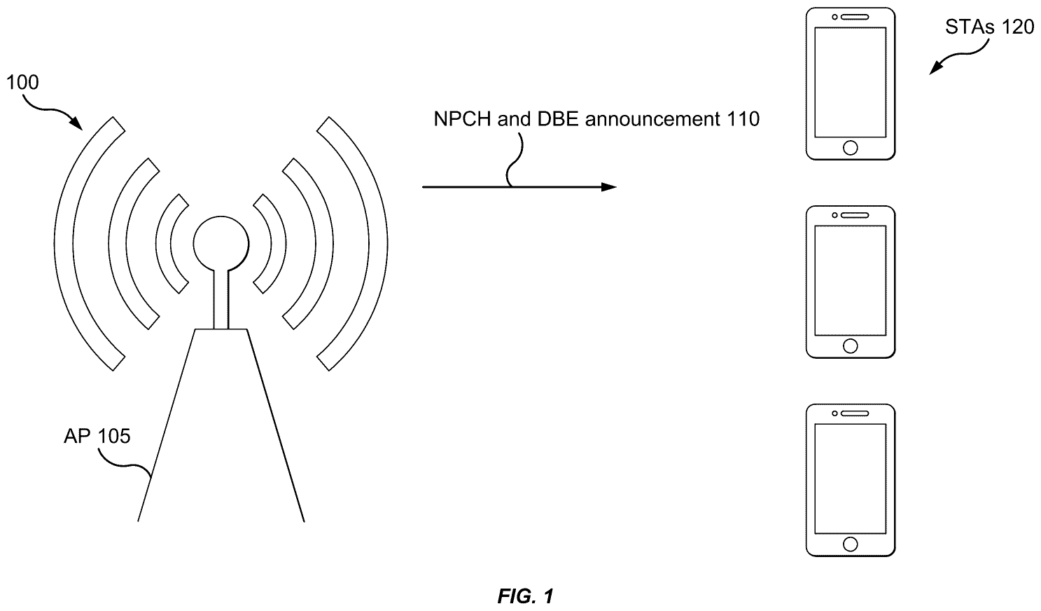

Now turning to the Figures, FIG. 1 illustrates a wireless network 100 that accounts for NPCA operation during DBE, according to one embodiment. FIG. 1 illustrates an AP 105 and several STAs 120 (e.g., mobile phones, tablets, laptops, desktop computers, etc.). It is assumed that the STAs 120 have already associated with the AP 105.

The AP 105 (or a network controller) can determine to initiate a DBE session in order to expand the BW of the BSS. For example, the load on the AP 105 may jump because the AP 105 is located in a conference room or an event center. To provide additional BW to serve the higher load, the AP 105 (or the RRM logic or controller) can determine to perform a DBE operation which makes the wider channel BWs available to the AP 105, e.g., 80 MHz, 160 MHz or 320 MHz.

In addition, the AP 105 may determine to update parameters related to NPCA, specifically NPCH in response to expanding the BW of the BSS. In one embodiment, NPCA operation may already be enabled in the BSS. That is, the AP 105 may have previously transmitted to the STAs 120 an NPCH that can be used when there is interference in the primary channel of the BSS (e.g., due to an OBSS transmission). It may be more efficient to define a NPCH that falls in the expanded BW of DBE when expanded DBE BW operation is enabled. This can be because an NPCH in the expanded BW is cleaner (less interference) and hence provides better chances of the AP or STA acquiring the channel access on the NPCH. In that case, the AP 105 can transmit an NPCH and DBE announcement 110 (which can include one or more messages or frames) that indicates a new NPCH that takes effect when the BW is expanded during the DBE session or mode. In one case, the new NPCH replaces any previous NPCH announced by the AP. In another case, the new NPCH becomes a second NPCH announced by the AP to be used for NPCA operation over the expanded DBE BW. In this case, the AP is indicating two NPCH channels, a first NPCA channel for NPCA over the BSS BW and a second NPCH for NPCA over the expanded DBE BW. In one case only one of these NPCH get used by the AP and the STAs at one point in time. For example, if DBE expanded BW operation is enabled, then the second NPCH indicated for NPCA over the expanded DBE BW is used by the AP and DBE supporting STAs. If DBE mode is disabled, then the first NPCH indicated for NPCA over the BSS BW gets used by the AP and the STAs (legacy STAs and DBE supporting STAs). In one case, if the bandwidth occupied by the OBSS PPDU observed on the primary channel is narrow and does not cover the first NPCH indicated for NPCA for BSS BW, then the AP and STAs may decide to use the first NPCH for NPCA operation when OBSS is detected over the primary channel. In another case, if the bandwidth occupied by the OBSS PPDU covers the first NPCH indicated for NPCA over BSS BW, then the AP and DBE supporting STAs may select the second NPCH for NPCA operation over the DBE BW.

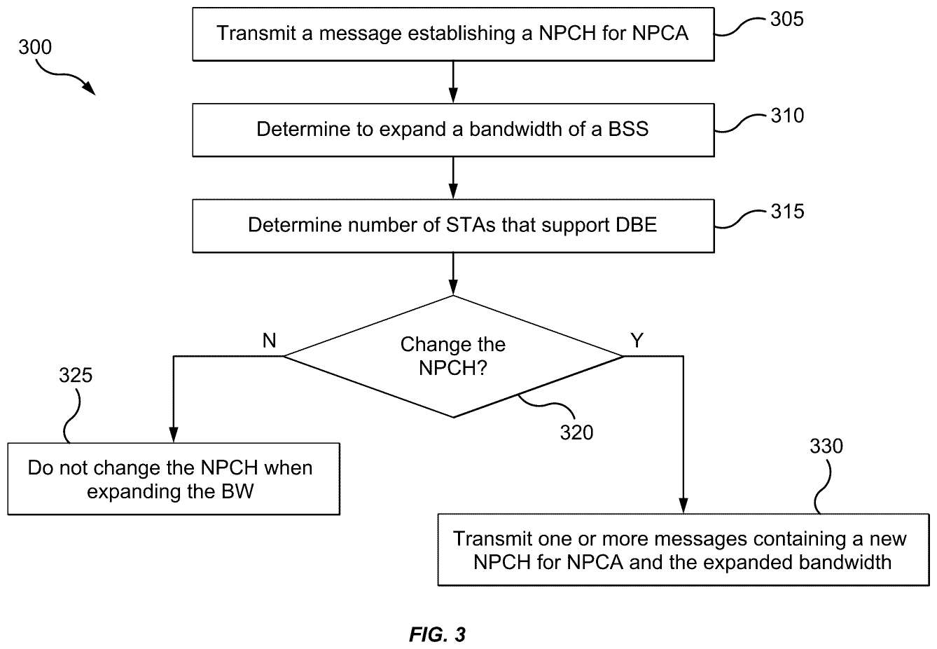

However, for STAs 120 that do not support DBE, they may not be able to perform NPCA in a NPCH that is within the expanded BW. Put differently, moving the NPCH to a channel within the expanded BW can mean legacy devices that are unable to support DBE no longer can perform NPCA. As such, in one embodiment, the AP 105 may poll the STAs 120 to determine how many can support DBE before deciding whether to switch to a new NPCH or stay with the current NPCH. This is discussed in more detail in FIG. 3.

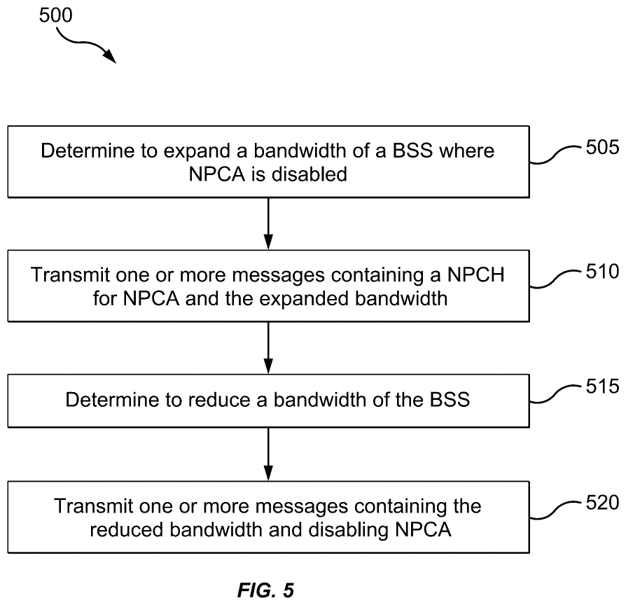

In another embodiment, NPCA may not currently be enabled in the BSS. For example, the BSS established by the AP 105 may not presently have enough BW to support a NPCH for performing NPCA. However, when the BW expands during the DBE session, the BSS may now have sufficient BW for a NPCH. In that case, the NPCH and DBE announcement 110 can establish an NPCH that enables NPCA (rather than changing the current NPCH to a new NPCH). In this manner, expanding the BW can also enable NPCA when previously it was disabled in the BSS. This is discussed more in FIG. 5.

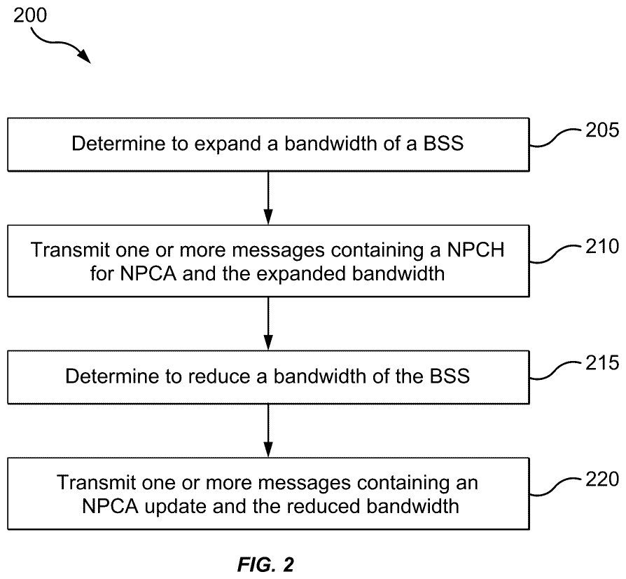

FIG. 2 is a flowchart of a method 200 for establishing a NPCH during DBE, according to one embodiment. At block 205, the AP determines to expand a bandwidth of a BSS it is part of. This decision can be determined by the AP itself, or because the AP receives an instruction from a network controller or RRM logic to expand its BW.

As mentioned above, the AP may expand its BW for any number of reasons. For example, DBE can be used to opportunistically expand BSS BW to exploit temporal variations in load and interference conditions among neighboring APs, e.g., expanding BSS BW from 40 MHz to 160 MHz for several seconds when low CCI or low CU is detected on adjacent channels leading to conclusions that the adjacent channels are “sufficiently clear” for BW expansion.

At block 210, the AP transmits, to the STAs connected to the BSS, one or more messages containing a NPCH for NPCA and the expanded BW. Put differently, the AP can inform the STAs of the expanded BW using any of the DBE signals and techniques discussed above. In addition, the AP establishes a NPCH for NPCA that is used during the DBE session (e.g., over the expanded bandwidth). In one embodiment, the NPCH transmitted at block 210 is a new NPCH that changes the current NPCH (assuming that NPCA is already enabled in the BSS). This is discussed in FIG. 3. Conversely, the messages transmitted at block 210 can enable NPCA and establish the NPCH (assuming that NPCA has not yet been enabled in the BSS). This is discussed in FIG. 5.

The DBE session can be announced in Beacon, Probe Response, or another management frame and can specify the DBE BW, DBE session start, or DBE session duration/end time. For example, the DBE announcement may indicate that the BSS is expanding from a 40 MHz BSS BW to a 160 MHz RT-DBE BW supporting STAs for 10 sec, starting in 200 TUs (or at TSF=current TSF+200 TU).

In one embodiment, the NPCH is announced in the same message (e.g., the same management frame) as the DBE session. That is, the NPCH (and related information such as channel width, center frequency, and punctured sub channel) can be in the same frame as the DBE information (e.g., DBE BW information, center frequency for the expanded BW, whether one or more sub-channel is punctured within the expanded BW, start time, duration/end time, etc.). For example, the NPCA information and the DBE information can be in the same message but organized as different set of parameters in the message. Moreover, the start time could be a shared parameter for the DBE and NPCA since it is advantageous for these to be synchronized. Ultra-high reliability (UHR) STAs that support NPCA or DBE can parse this announcement to determine the changes to NPCH or upcoming DBE sessions.

In one embodiment, the AP announces its DBE NPCH switching delay for switching to a channel in the DBE BW. In the context of DBE, the switching delay indicates the time used by a STA and AP to configure its hardware (e.g., radios) to begin using the DBE BW. In the context of NPCA, the switching delay is the time used by the STA and AP when they detect the OBSS transmission in the primary channel and switch to the NPCH.

The AP can define multiple switching delays for NPCH channels in different parts of the DBE BW (e.g. one switching delay for NPCH in DBE BW S80 (secondary 80 MHz) and another delay for NPCH in DBE BW S160 (secondary 160 MHz)). In another embodiment, the AP can instead just report its maximum switching delay to any channel in the DBE BW. The AP can announce its NPCH switching delay(s) in a management frame(s) (Beacon, Probe Response) with its DBE capability and parameters or with NPCA capability/parameters. Alternatively, or in addition to, the AP can also announce its DBE and NPCH switching delays in the DBE announcement for a given DBE session.

Each DBE-capable STA can also announce its NPCH switching delay indicating delay for switching to the NPCH in the DBE-BW when there is an OBSS transmission in the primary channel. This can be provided by the STA as part its DBE parameters in a management frame, e.g., a (Re)Association frame or a DBE notification frame, operating mode notification (OMN) frame or another frame. A DBE-capable STA may announce a single NPCH switching delay for any NPCH channel in the DBE BW or may announce multiple NPCH switching delays for different NPCH channels in DBE BW. Multiple switching delays may be indicated if a STA's radio hardware takes significantly different times for switching to two different channels over a wider DBE BW. For example, for DBE BW from 80 MHz to 320 MHz, a STA may provide NPCH switching delay of 200 usec for a NPCH in S80, and a different (higher) NPCH switching delay of 400 usec for a NPCH in S160.

If announced for a DBE session, the NPCH is used by the AP and the DBE-capable STAs for their NPCA operation during the time duration of that DBE session. The AP and STA honor the NPCH switching delay corresponding to the NPCH channel, as indicated by the other peer, when transmitting on the DBE NPCH during the DBE session.

Transmitting the message at block 210 can enable the NPCA operation for the BSS or update the NPCH for the BSS if the NPCA operation was already enabled in the BSS.

At block 215, the AP determines to reduce the BW of the BSS (e.g., reduce the BW back to the original or default BW of the BSS). This decision can be determined by the AP itself, or because the AP receives an instruction from a network controller or RRM logic to reduce its BW. Thus, in this example, the DBE session continues until the AP determines to reduce the BW (e.g., due to a change in load conditions at the AP or an increase of CCI or CU). However, in other embodiments, the DBE session may have a fixed duration. In that case, the messages transmitted at block 210 may inform the STAs of the fixed duration of the DBE session after which the BSS BW returns to its original value. In that case, the STAs would not have to be informed when to reduce the BSS BW.

At block 220, the AP transmits one or more messages containing an NPCA update and the reduced BW to the STAs. If NPCA was already established in the BSS before the DBE session, the NPCA update may indicate that the STAs should switch back to using the previous NPCH. However, if NPCA was not established in the BSS before the DBE session, the NPCA update may indicate that NPCA is again being disabled.

However, if the DBE session had a fixed duration, then the STAs may automatically revert to the previous state of NPCA once the DBE session expires (e.g., block 220 can be omitted). For instance, if NPCA was previously enabled, once the DBE session expires the STAs can automatically switch back to using the previous NPCH. Or if NPCA was not previously enabled, once the DBE session expires the STAs know that NPCA is no longer available (i.e., has been disabled)

FIG. 3 is a flowchart of a method 300 for changing a NPCH during DBE, according to one embodiment. At block 305, the AP transmits a message establishing a NPCH for NPCA. The first message can advertise the NPCH before there is any problem detected on the primary channel of the BSS. Then, when an OBSS transmission is detected on the primary channel, the AP and the STAs can use the NPCH indicated in the first message to contend for wireless resources—i.e., the NPCH can be used as the primary channel of the BSS.

In one embodiment, both the AP and STA indicate whether they support NPCA in an NPCA Supported field (or indication) as part of UHR Capabilities. As mentioned above, NPCA currently supports NPCA operation within the BSS BW. In one option, the NPCA Supported field can extend to also indicate that NPCA is supported for DBE BW. That is, the NPCA supported field can indicate that NPCA is supported over the BSS BW and over the DBE BW when DBE is supported. If a STA/AP supports DBE and also supports NPCA, it supports NPCA over both BSS BW and DBE BW. If a STA/AP does not support DBE, the NPCA Supported field indicates NPCA support over the BSS BW. In one embodiment, the NPCA Supported field can provide flexibility for a DBE supporting STA/AP to support NPCA only over BSS BW or only over DBE BW.

In another option, the NPCA Supported field indicates NPCA support over the BSS BW. A new field such as ‘NPCA Supported over the DBE BW’ is defined e.g. in the UHR Capabilities to indicate support for NPCA over the expanded DBE BW. An AP/STA that supports NPCA over the DBE BW would set this field to 1. An AP/STA that supports DBE but only supports NPCA over the BSS BW, would set this field to 0. This new field provides the flexibility to AP and STAs to support NPCA over the DBE BW or not support NPCA over DBE BW, independent of NPCA support over the BSS BW. This flexibility may be useful e.g. in cases where AP may only see the benefit of doing NPCA over wider DBE BW, or STA may not support/implement NPCA over wider BW (but can support NPCA over BSS BW).

For NPCA, in one embodiment, the AP can dynamically enable/disable NPCA mode using the UHR critical update mechanism. A field such as NPCA Enabled in UHR Operation element can indicate whether NPCA is enabled for the BSS. Current structure of this field implies that the NPCA is enabled for the BSS BW, and the NPCH is within the BSS BW. When DBE mode is enabled, AP can enable NPCA over DBE BW and can indicate that in a UHR Operation element. In one option, the NPCA Enabled indication is extended to also indicate that NPCA is enabled for DBE BW when the DBE mode is enabled. In this example, since the bit is overloaded to indicate NPCA over BSS BW or NPCA over DBE BW, which mode is enabled can be determined using NPCH. If the NPCH indicated by the AP falls within the BSS BW, then NPCA is enabled over the BSS BW. In this case, STAs that operate only within the BSS BW can perform NPCA operation and STAs that can operate over the expanded DBE BW can also perform NPCA operation using the NPCH defined within the BSS BW. When STAs and AP operate on the NPCH in this case, for STAs that support DBE, RUs (resource unit) allocation can be over the expanded BW (and is not limited to the BSS BW). If the NPCH indicated by the AP falls outside the BSS BW and within the DBE BW, then NPCA is enabled over the DBE BW. In this case, DBE supporting STAs that support operation over the indicated NPCH perform NPCA operation. If there are DBE supporting STAs that do not support operation over the indicated NPCH, then those STAs will not perform NPCA. For example, if expanded DBE BW is 320 MHz and some STAs support max DBE BW of 160 MHz but the majority of STAs support a max DBE BW of 320 MHz, then an AP may select NPCH to be in secondary 160 (S160) sub-band. In this case, STAs that support max DBE BW of 160 MHz cannot operate on an NPCH in S160 sub-band and hence do not perform NPCA operation. STAs that support max DBE BW of 320 MHz can operate on NPCH in S160 and can perform NPCA. Non-DBE non-AP STAs may perform NPCA only if the NPCH is within the BSS BW.

In another option, the NPCA Enabled field indicates that NPCA is enabled over the BSS BW. A new field such as ‘NPCA Enabled over the DBE BW’ can be defined to indicate whether NPCA is enabled over the DBE BW. This new field is set to 1 by the AP to enable NPCA over DBE BW and set to 0 otherwise. This provides flexibility to the AP to explicitly enable NPCA for BSS BW or for DBE BW. In some cases, the AP may detect NPCA gains only over DBE BW, then the AP may only enable NPCA over the DBE BW. This also allows non-DBE supporting STAs to know if NPCA is enabled for BSS BW based on a separate enablement indication of NPCA over BSS BW, instead of determining this based on the NPCH, where a non-DBE STA will determine to perform NPCA if NPCH is within the BSS BW and not perform NPCA if NPCH is outside the BSS BW.

At block 310, the AP determines to expand a bandwidth of a BSS. This can be for any of the reasons discussed above, e.g., in block 205 of method 200.

In one embodiment, when NPCA was disabled before DBE BW expansion, an AP can transmit a critical update notification for enabling NPCA over DBE BW when DBE mode is being enabled. For example, an AP that wants to enable NPCA over the DBE BW when enabling DBE mode, can send a critical update (CU) notification for NPCA. NPCA CU notification may indicate that NPCA is enabled over the DBE BW and the NPCH within the DBE BW, provide an NPCA Disabled Subchannel Bitmap parameter indicating disabled/punctured subchannels over DBE BW for NPCA operation, and updated NPCA Switch time parameters or other NPCA related parameters if applicable for NPCA over DBE BW.

In another case, if NPCA was already enabled, then an NPCA CU notification can be sent to indicate NPCA enablement over the DBE BW (either explicitly or by indicating NPCH in the DBE BW), updated NPCA parameters such as an NPCH within the DBE BW plus NPCA Disabled Subchannel Bitmap for NPCA operation in DBE BW and any other applicable NPCA parameters.

In both cases described above, the NPCA Disabled Subchannel Bitmap may be different than the DBE Disabled Subchannel Bitmap, because for the NPCA Disabled Subchannel Bitmap the primary 20 MHz sub-band (P20) would be punctured but P20 may not be punctured in the DBE Disabled Subchannel Bitmap. In one embodiment, the NPCA Disabled Subchannel Bitmap also punctures the subchannels that are disabled in the DBE Disabled Subchannel Bitmap. This is desirable because any 20 MHz sub-band puncturing that is done in the DBE BW would also have to be punctured when AP and STAs are operating over the DBE BW using NPCA operation e.g. for regulatory reasons. The NPCA Disabled Subchannel Bitmap can puncture more sub-bands including puncturing subchannel P20 and possibly other sub-bands.

In one embodiment, the NPCA CU notification is sent along with the DBE CU notification (for enabling/updating DBE mode). These CU notifications can start at the same time, e.g., start time/switch time for CU for NPCA over DBE BW is same as for DBE CU. In some cases, the AP may enable NPCA over DBE BW after the DBE mode is enabled (or updated) by sending an NPCA CU notification that takes effect at a later point in time.

When the STA learns that the NPCA is enabled over the DBE BW, the STA indicates enable/disable for NPCA mode to the AP using, e.g., the UHR defined mechanism to enable/disable/update operating modes. If the STA supports NPCA, the STA can enable NPCA mode over BSS BW or DBE BW or both.

To perform NPCA over the DBE BW, first STA may enable NPCA over DBE BW with the AP using UHR defined mechanism to enable/disable/update operating modes. In one option, if the NPCA is enabled by STA that supports DBE mode, this indicates that the STA has enabled NPCA for both BSS BW and DBE BW. In another option, a STA that supports DBE mode indicates separate enablement for NPCA over DBE BW (e.g. using an ‘NPCA Enabled over DBE BW’ field in the UHR defined mechanism to enable/disable/update operating modes). In both options, the STA may provide a different set of NPCA switch delay, NPCA switchback delay and any other applicable parameters for NPCA over DBE BW.

To avoid a rush of STAs enabling NPCA over DBE BW when DBE mode is enabled by the AP, the STAs can enable NPCA over DBE BW even before DBE mode is enabled, if the AP supports NPCA over DBE BW (per AP's capability indication).

In one embodiment, a non-DBE supporting STA does not perform NPCA operation if NPCA is not enabled over the BSS BW based on the enablement indication or NPCH indicated is outside the BSS BW.

At block 315, the AP determines the number of STAs that support DBE using any of the signal discussed in the previous blocks. For example, some of the STAs in the BSS (and connected to the AP) may be legacy devices that are unable to support DBE. As such, if the NPCH were moved to the DBE BW established for a DBE session, these STAs would lose their ability to perform NPCA.

At block 320, the AP determines whether to change the NPCH to include (or be within) the DBE BW of the DBE session. For example, if a threshold number of STAs or a threshold percentage of the STAs are legacy STAs that would lose their ability to perform NPCA if the NPCH is moved to the expanded DBE BW, then the AP may decide to not change the NPCH so these STAs can continue to perform NPCA. Or there may be little interference on the current NPCH such that little performance would be gained by moving the NPCH to be within the DBE BW. However, if the threshold is not met or the current NPCH has significant interference observed, the AP may decide to change the NPCH even if it means some of the STAs may lose their ability to perform NPCA. The DBE-capable STAs that can use the new NPCH can benefit from having a cleaner NPCH with less interference which provides better chances of the AP or STA operating on the NPCH. This can result in an overall benefit to the performance of the BSS (especially if the number of legacy STAs is small).

If the AP determined not to change the NPCH during the DBE session, the method 300 proceeds to block 325 where the AP signals the expanded BW for DBE to the STAs, but does not inform the STAs to change the NPCH used to perform NPCA. The current NPCH can still be available for performing NPCA for both legacy STAs and DBE supporting STAs. For example, if not changing the NPCH, the AP may not provide any NPCH channel along with the DBE session, or the AP sends an unchanged value or AP does not send an NPCA critical update (CU) that changes the NPCH.

If the AP determines to change the NPCH during the DBE session, the method 300 proceeds to block 330 where the AP transmits one or more messages containing a new NPCH for NPCA along with the expanded DBE bandwidth announcement. The AP may send a critical update (CU) for changing the NPCH for DBE BW where AP indicates a new NPCH that is in the expanded DBE BW. The NPCA CU can indicate the switch time/start time when the new NPCH would become effective and this time could be same as the switch time for DBW mode enablement/update. In this case, legacy STAs that do not support DBE may lose the ability to perform NPCA, but the DBE-capable STAs can benefit from an NPCH where there is less interference observed from OBSS.

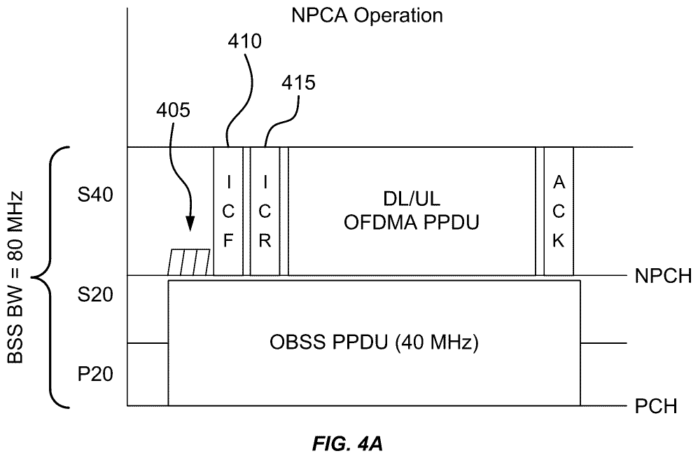

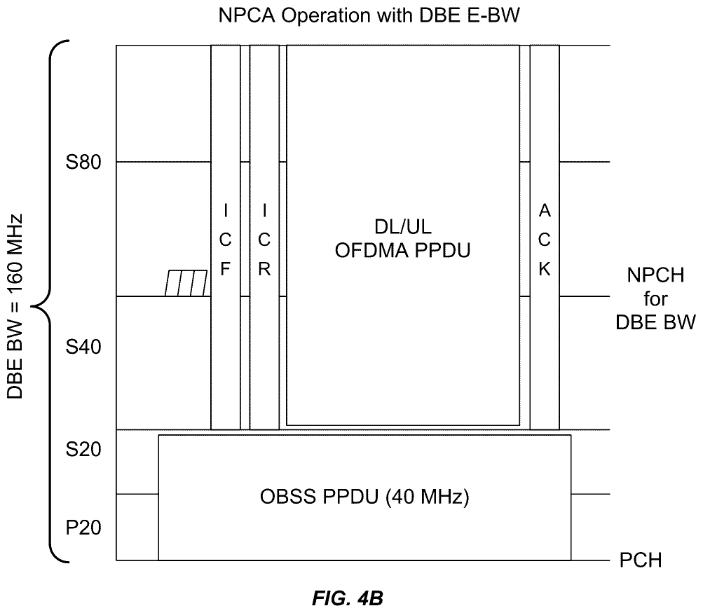

FIGS. 4A and 4B illustrate changing an NPCH during DBE, according to one embodiment. FIG. 4A illustrates an example BSS operating BW before DBE while FIG. 4B illustrates the BSS operating BW during DBE.

FIG. 4A illustrate a BSS operating BW of 80 MHz. In this case, the primary channel (PCH) of the BSS is the lower channel of the P20 sub-band and BSS is operating over P20, S20 (secondary 20 sub-band) and S40 (secondary 40 sub-band) over a total of 80 MHz BSS operating BW. The NPCH is indicated as the lower channel of S40 sub-band. As mentioned above, if an OBSS transmission is detected on the PCH, the STAs and APs can switch to the NPCH for DL and UL transmissions.

The NPCA process is illustrated in FIG. 4A which starts with a channel contention and acquisition stage on the NPCH 405 followed by typically an initial control frame (ICF) 410 and an initial control response (ICR) 415 exchanged between the AP and the STA. In one case, explicit ICF and ICR may not be exchanged after channel acquisition on the NPCH. The AP and STA can then exchange traffic on the NPCH over S40 sub-band. On NPCH, using OFDMA (Orthogonal Frequency-Division Multiple Access), a PPDU (Physical Layer Protocol Data Unit) can be transmitted in either Downlink (DL) or Uplink (UL) directions. DL OFDMA allows the AP to transmit data to multiple clients simultaneously by dividing the channel into Resource Units (RUs). Conversely, UL OFDMA enables AP to trigger multiple clients to transmit data to the AP concurrently, also using allocated RUs.

Once the DBE session begins, FIG. 4B illustrates the operating BW for the AP increasing from the 80 MHz in FIG. 4A to 160 MHz. In this example, the PCH remains the same but the AP has moved the NPCH to the lower channel of S80 sub-band, which is in the expanded DBE BW. The AP and DBE-capable STAs use the new NPCH to perform NPCA during the time when DBE session is enabled.

During the DBE session time, in one embodiment the AP also indicates the NPCH in the NPCA parameters outside the DBE announcement. The STAs that do not support DBE operation (e.g., legacy device) or for DBE supporting STAs for which the NPCH channel falls outside their supported max DBE BW or operating BW, can temporarily disable NPCA operation. The STA can indicate disabling of NPCA either via a UHR management frame, UHR Operating Mode Notification (OMN) frame, a DBE notification frame (or another management frame), a Link Reconfiguration Request frame, a Link Reconfiguration Notify frame or in-band using a UHR A-Control field. In another case, the STA can decide to disable NPCA locally without sending any indication for NPCA disablement to the AP. When the DBE expanded BW session ends meaning the AP is no longer operating with expanded DBE BW, the AP updates the NPCH to an updated NPCH within the BSS BW, e.g., by sending a UHR critical update signaling for NPCA, and these STAs can then enable their NPCA operation using management frame or in-band signaling or implicitly (if STA never disabled NPCA with the AP when DBE session was enabled).

In another embodiment, the NPCA disablement signaling might be omitted, and be implied based on the STA's lack of other capabilities (e.g., no support for DBE above the BSS BW such that, for a BSS of 40 MHz BSS BW expanding to 160 MHz where the NPCH lies in the S80, the STA could not use the NPCH).

In one case, while the legacy (or non-DBE-capable) STAs cannot perform NPCA when the BW has been expanded at FIG. 4B, there still can be communication between the AP and these legacy STAs over S40 sub-band if legacy STAs are listening over channels in S40 sub-band. For example, the AP can serve the legacy STAs using DL OFDMA PPDU, or trigger those STA for sending an uplink OFDMA PPDU. The RUs can be located in S40 to legacy STAs that do not support DBE. Thus, legacy STAs can continue to use the sub-band S40 for communication with the AP, but will not perform NPCA. Once the DBE session has ended and the NPCH returns to a channel within the BSS BW as shown in FIG. 4A, then these legacy STAs can once again perform NPCA.

FIG. 5 is a flowchart of a method 500 for enabling NPCA over expanded DBE BW during DBE operation, according to one embodiment. At block 505, the AP determines to expand a bandwidth of its BSS where the NPCA is currently disabled in the BSS. For example, the BSS operating BW may be too small to support NPCH - e.g., the AP may not enable NPCA for a 40 MHz BSS BW.

At block 510, the AP transmits one or more messages containing an NPCH for NPCA over the expanded bandwidth. This can be performed using any of the techniques discussed above. However, instead of changing from an old NPCH to a new NPCH, the one or more messages establish an NPCH for enabling NPCA over the DBE BW. When the AP expands the BW with DBE, the AP can enable NPCA operation for the DBE BW at the same time, including synchronization of enablement times for DBE and NPCA over DBE BW, and synchronization of switching delays of each method can minimize BSS outage (i.e. as opposed to an DBE BW induced radio re-tune followed by an NPCA induced re-tune).

The AP can announce that the NPCA will be enabled for the DBE session as part of the DBE critical update announcement and provide the DBE and NPCH switching delay(s). The AP can also provide a separate critical update announcement for enabling NPCA over the DBE BW. The DBE-capable STAs can then perform NPCA on the NPCH during the time when DBE session is enabled.

At block 515, the AP determines to reduce the BW of the BSS, for any of the reasons discussed above.

At block 520, the AP transmits one or more messages containing the reduced BW and disables NPCA. That is, the AP switches back to non-NPCA operation after the DBE session ends, by disabling the NPCA operation. In this example, the STAs perform NPCA only during the DBE session duration. The AP can transmit a critical update (CU) for DBE to reduce the DBE BW to the BSS BW to disable DBE operation, and may transmit NPCA disablement in the same CU or a separate CU for NPCA disabling NPCA operation. In another case, the AP may not disable NPCA when the DBE expanded BW operation is disabled, but change the NPCH to a new NPCH within the BSS BW using an NPCA CU.

While the method 500 describes transmitting one or more messages to reduce the BW (i.e., end the DBE session) and disable NPCA, in other embodiments the one or more messages transmitted at block 510 may indicate a duration (or an end time) of the DBE session. In that case, the STAs and AP can automatically reduce their operating BW and stop using NPCA once the DBE session has expired, without having to send additional messages at block 520.

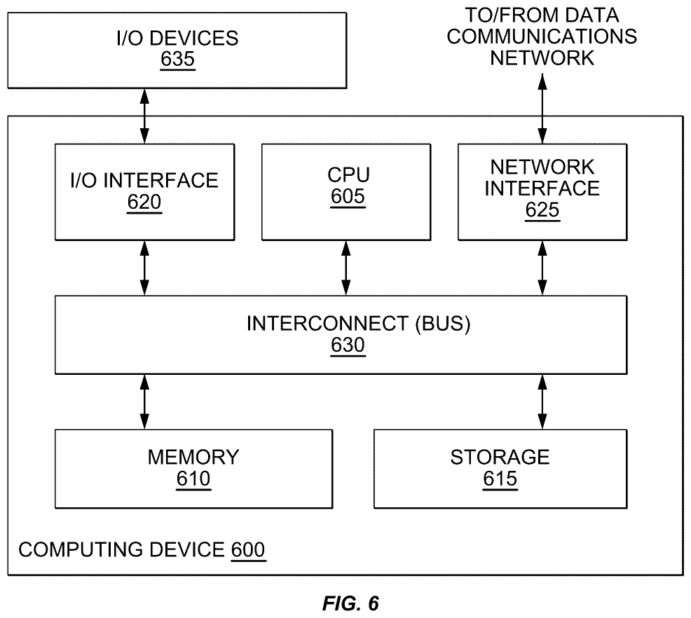

FIG. 6 depicts an example computing device configured to perform various aspects of the present disclosure, according to one embodiment. Although depicted as a physical device, in embodiments, the computing device 600 may be implemented using virtual device(s), and/or across a number of devices (e.g., in a cloud environment). In one embodiment, the computing device 600 corresponds to a network device (e.g., a computing system), such as the APs or the STAs (e.g., user devices) mentioned above.

As illustrated, the computing device 600 includes a CPU 605 (one or more processors), memory 610 (or memories), storage 615, a network interface 625, and one or more input/output (I/O) interfaces 620. In the illustrated embodiment, the CPU 605 retrieves and executes programming instructions stored in memory 610, as well as stores and retrieves application data residing in storage 615. The CPU 605 is generally representative of a single CPU and/or GPU, multiple CPUs and/or GPUs, a single CPU and/or GPU having multiple processing cores, and the like. The memory 610 is generally included to be representative of a random access memory. Storage 615 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, storage 615, network interface(s) 625, and I/O interface(s) 620 are communicatively coupled by one or more buses 630.

The memory 610 can include software programs or application for establishing the NPCH for NPCA, changing the NPCH, and for performing DBE as discussed above in FIGS. 1-5. Although shown as residing in memory 610, in embodiments, the operations of discussed above (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system. ” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point (AP), comprising:
one or more memories; and
one or more processors communicatively coupled to the one or more memories, wherein the one or more processors are configured to, individually or collectively, perform operations comprising:
determining to expand a bandwidth of a basic service set (BSS); and
in response to determining to expand the bandwidth, transmitting a message comprising a primary channel for performing Non-Primary Channel Access (NPCA) over the expanded bandwidth.

2. The AP of claim 1, wherein the message further announces the expanded bandwidth and a start time when the expanded bandwidth will take effect.

3. The AP of claim 2, wherein the message further includes a start time when the primary channel for NPCA will take effect, wherein the start time when the primary channel for NPCA will take effect is at a same time or later than the start time when the expanded bandwidth will take effect.

4. The AP of claim 3, wherein transmitting the message enables NPCA operation for the BSS or updates the primary channel for performing NPCH for the BSS if the NPCA operation was already enabled in the BSS.

5. The AP of claim 3, wherein the start time when the primary channel for NPCA will take effect, indicates (1) a number of target beacon transmission times (TBTTs) or beacon intervals after which the primary channel for NPCA takes effect or (2) a timing synchronization function (TSF) time when the primary channel for NPCA takes effect.

6. The AP of claim 2, wherein the message is transmitted as part of beacon frame, probe response frame, association response frame, reassociation response frame or another management frame.

7. The AP of claim 2, further comprises transmitting the message using a UHR critical update notification that provides at least one of:
an indication whether NPCA is enabled or disabled,
an NPCH field indicating the NPCA primary channel for NPCA operation over expanded bandwidth,
an NPCA switching delay and an NPCA switchback delay for NPCA operation over expanded bandwidth, or
NPCA disabled subchannels for NPCA operation over the expanded bandwidth.

8. The AP of claim 6, wherein the primary channel for NPCA is used for performing NPCA operation for a period for which bandwidth is expanded or until the primary channel for NPCA is update.

9. The AP of claim 1, wherein the operation further comprises indicating one primary channel for performing Non-Primary Channel Access (NPCA) over the expanded bandwidth and another primary channel for performing NPCA over the bandwidth of the BSS.

10. The AP of claim 1, wherein the operations further comprise, before transmitting the message comprising the primary channel:
determining a number of stations associated with the AP that will be unable to perform NPCA if the primary channel used to perform NPCA is within the expanded bandwidth,
wherein the message is transmitted after determining that the number of stations unable to perform NPCA is less than a threshold.

11. The AP of claim 1, wherein, the operations further comprises,
disabling NPCA over the expanded bandwidth or disabling NPCA for the BSS when the expanded bandwidth is reduced to the BSS bandwidth.

12. The AP of claim 1, wherein the operations further comprise:
transmitting an indication by the access point in UHR Capabilities that indicates that NPCA is supported for the expanded bandwidth by the AP, and
receiving an indication from a station in UHR Capabilities that indicates that NPCA is supported for the expanded bandwidth by the station.

13. The AP of claim 12, wherein the indication that the NPCA is supported over the expanded bandwidth is different from the indication that NPCA is supported over a bandwidth of the BSS.

14. The AP of claim 1, wherein the operation further comprises signaling by the AP that NPCA is enabled over the expanded bandwidth in an UHR Operation element.

15. The AP of claim 1, wherein the operation further comprises receiving from a station a message signaling enablement of NPCA over the expanded bandwidth for the station, wherein the message optionally includes an NPCA switching delay and an NPCA switchback delay for NPCA operation over the expanded bandwidth.

16. The AP of claim 1, wherein the operation further comprises receiving from a station a message to enable NPCA over the expanded bandwidth before the AP transmits a message indicating operation over the expanded bandwidth.

17. The AP of claim 1, wherein a station does not perform NPCA operation if the primary channel for performing NPCA transmitted by the AP is outside an operating bandwidth of the station.

18. A method comprising:
determining to expand a bandwidth of a basic service set (BSS); and
in response to determining to expand the bandwidth, transmitting a message from an access point (AP) that comprises a primary channel for performing Non-Primary Channel Access (NPCA) over the expanded bandwidth.

19. The method of claim 18, wherein the message further announces the expanded bandwidth and a start time when the expanded bandwidth will take effect.

20. A non-transitory computer-readable medium containing, in any combination, computer program code, which, when executed by one or more processors, performs operations comprising:
determining to expand a bandwidth of a basic service set (BSS); and
in response to determining to expand the bandwidth, transmitting a message from an access point (AP) comprising a primary channel for performing Non-Primary Channel Access (NPCA) over the expanded bandwidth.
